(19) United States
(12) Patent Application Publication
(10) Pub. No.: US 2003/0140725 A1
(43) Pub. Date: Jul. 31, 2003

(54) Manual shift mechanism of a bicycle

(76) Inventor: Jen-Chih Liu, Kaohsiung (TW)

Correspondence Address: Keith Kline, PRO-TECHTOR INTERNATIONAL SERVICES, 20775 Norada Court, Saratoga, CA, 95070-3018, US

(21) Appl. No.: 10/374,647

(22) Filed: Feb. 25, 2003

Related U.S. Application Data
(63) Continuation-in-part of application No. 09/791,483, filed on Feb. 22, 2001.

(51) Int. Cl. F16C 1/10

(52) U.S. Cl. 74/502.2

(57) ABSTRACT

The manual shift mechanism of a bicycle, which is mounted on a handle of the bicycle. The shift mechanism includes a front cord-guiding casing and a rear rotary sleeve mated with the front casing. A shift member is disposed between the front casing and the rear rotary sleeve and is driven by the rear rotary sleeve. The shift member is displaceable to selectively directly mesh with a ring gear for pulling and releasing a transmission pull cord or mesh with a planet gear which is drivingly engaged with the ring gear for pulling and releasing the transmission pull cord. When the ring gear is engaged with and driven by the shift member, the gears are one by one shifted and when the ring gear is engaged with and driven by the planet gear of the planet gear frame, the gear is several times shifted by way of jumping.

### BACKGROUND OF THE INVENTION

The present invention is related to a manual shift mechanism of a bicycle, in which the gears can be sequentially shifted or shifted by skipping gears.

A conventional bicycle transmission mechanism includes a shift lever which pulls and releases a pull cord for operating the transmission mechanism. In operation, a user must pull and release the shift lever with his fingers. During operation, this often makes the user lose his/her concentration and causes a delay while racing. Accordingly, safety cannot be ensured and the operation is inconvenient.

An improved shift mechanism has been developed, which is disposed on the handle of the bicycle. When shifting, a user can turn the handle to pull and release the pull cord. Such a shift mechanism is disclosed in U.S. Pat. Nos. 4,900,291, 4,938,733, 5,315,891 and 5,197,927.

In all the above conventional manual shift mechanisms of bicycles, the gears can be only sequentially shifted. With a fixed rotational angle, it is impossible for all these shift mechanisms to shift through several gears at one time.

### SUMMARY OF THE INVENTION

It is therefore a primary object of the present invention to provide a manual shift mechanism of a bicycle, in which the gears can be sequentially shifted or several gears can be skipped. Therefore, the shifting operation can be more easily performed.

The present invention can be best understood through the following description and the accompanying drawings wherein:

### BRIEF DESCRIPTION OF THE DRAWINGS

FIG. 1 is a perspective exploded view of the present invention;

FIG. 2 is a plane view of the front cord-guiding casing of the present invention;

FIG. 3 is a top view according to FIG. 2;

FIG. 4 is a right view according to FIG. 2;

FIG. 5 is a plane view of the gear number indicator of the present invention;

FIG. 6 is a top view according to FIG. 5;

FIG. 7 is a right view according to FIG. 5;

FIG. 8 is a plane view of the fixing hoop of the present invention;

FIG. 9 is a top view according to FIG. 8;

FIG. 10 is a right view according to FIG. 8;

FIG. 11 is a plane view of the locating member of the present invention;

FIG. 12 is a top view according to FIG. 11;

FIG. 13 is a right view according to FIG. 11;

FIG. 14 is a rear view according to FIG. 11;

FIG. 15 is a plane view of the serially fitting member of the present invention;

FIG. 16 is a top view according to FIG. 15;

FIG. 17 is a right view according to FIG. 15;

FIG. 18 is a plane view of the ring gear of the present invention;

FIG. 19 is a top view according to FIG. 18;

FIG. 20 is a right view according to FIG. 18;

FIG. 21 is a rear view according to FIG. 18;

FIG. 22 is a plane view of the planet gear frame of the present invention;

FIG. 23 is a top view according to FIG. 22;

FIG. 24 is a right view according to FIG. 22;

FIG. 25 is a plane view of the sun gear of the present invention;

FIG. 26 is a top view according to FIG. 25;

FIG. 27 is a right view according to FIG. 25;

FIG. 28 is a plane view of the shift member of the present invention;

FIG. 29 is a top view according to FIG. 28;

FIG. 30 is a right view according to FIG. 28;

FIG. 31 is a plane view of the rear rotary sleeve of the present invention;

FIG. 32 is a top view according to FIG. 31;

FIG. 33 is a right view according to FIG. 31;

FIG. 34 is a plane view of the fast ring of the present invention;

FIG. 35 is a top view according to FIG. 34;

FIG. 36 is a right view according to FIG. 34; and

FIG. 37 is a rear view according to FIG. 34.

### DETAILED DESCRIPTION OF THE PREFERRED EMBODIMENT

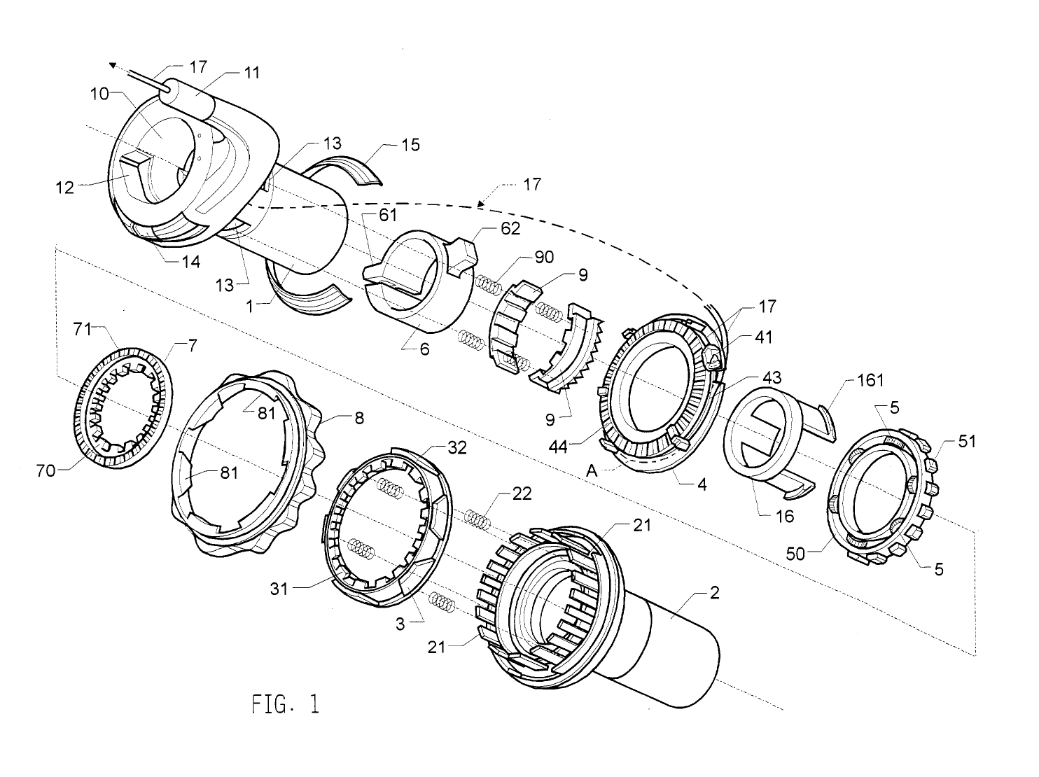

Please refer to FIG. 1. The manual shift mechanism of a bicycle of the present invention includes a front cord-guiding casing 1 and a rear rotary sleeve 2. A shift member 3 is disposed between the front casing 1 and the rear rotary sleeve 2 and is driven by the rear rotary sleeve 2. By means of selectively shifting the shift member 3, a ring gear 4 can be driven to pull and release a pull cord 17. Alternatively, via a planet gear 5 meshing with the ring gear 4, the ring gear 4 can be driven to pull and release the pull cord 17 across several gears.

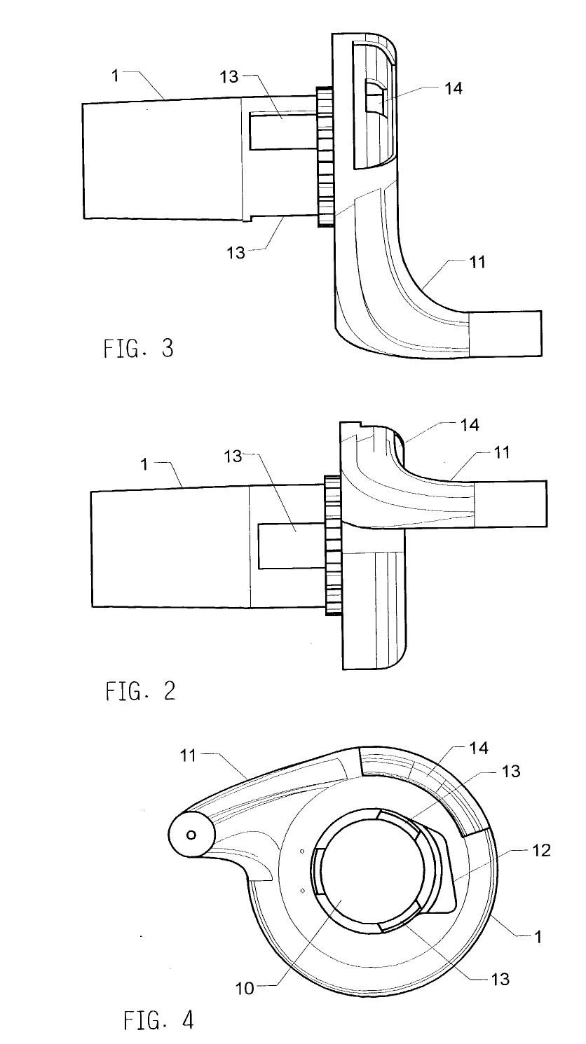

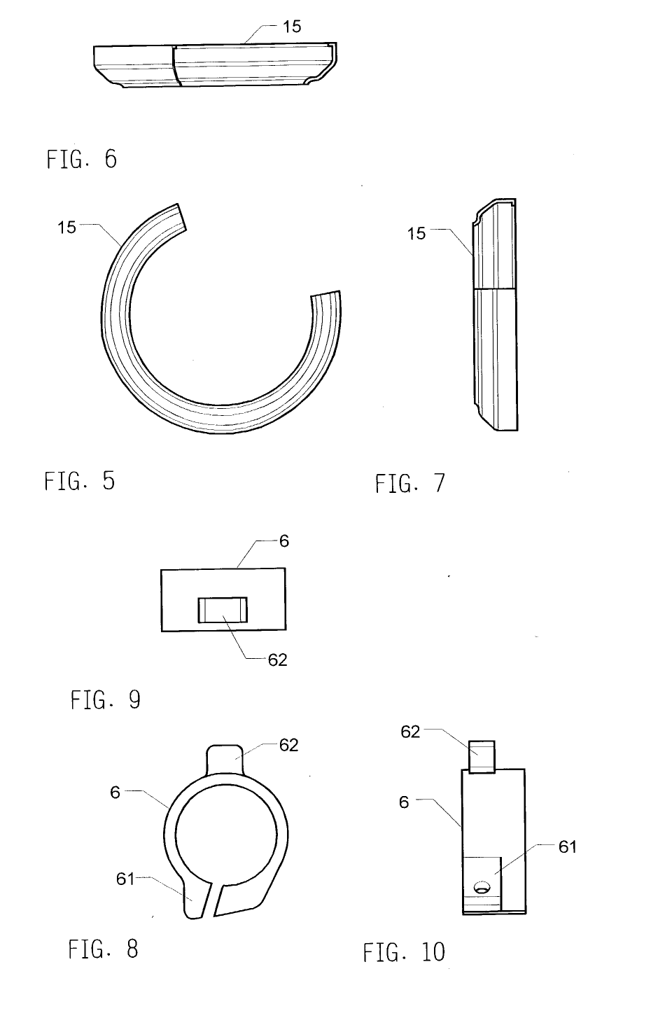

Please refer to FIGS. 1 and 2 to 4. The front casing 1 is formed with a cord-guiding arm 11 through which the transmission pull cord 17 is passed to connect with a pull cord locating seat 41 of the ring gear 4. The front casing 1 is formed with a central passage 10 through which a handle is passed. In addition, the entrance of the passage 10 is provided with a locating recess 12 for locating a fixing hoop 6 (as shown in FIGS. 8 to 10). The front casing 1 is further formed with a window 14. A built-in gear number indicator 15 (as shown in FIGS. 5 to 7) is connected with the ring gear 4. The gear number indicator 15 serves to indicate the shift position of the ring gear 4 through the window 14. A rear collar section of the front casing 1 is formed with at least one locating bore 13. A hooking claw 161 of a fitting member 16 (as shown in FIGS. 15 to 17) protrudes through the locating bore 13 out of the collar section for serially locating relevant components.

Referring to FIGS. 1 and 8 to 10, the fixing hoop 6 has an outward projecting locating block 61 formed with a split. A screw can be screwed through the locating block 61 to fix the shift mechanism on the handle. A projecting block 62 of the fixing hoop 6 is inlaid in the locating recess 12 of the front casing 1, whereby the front casing 1 is secured.

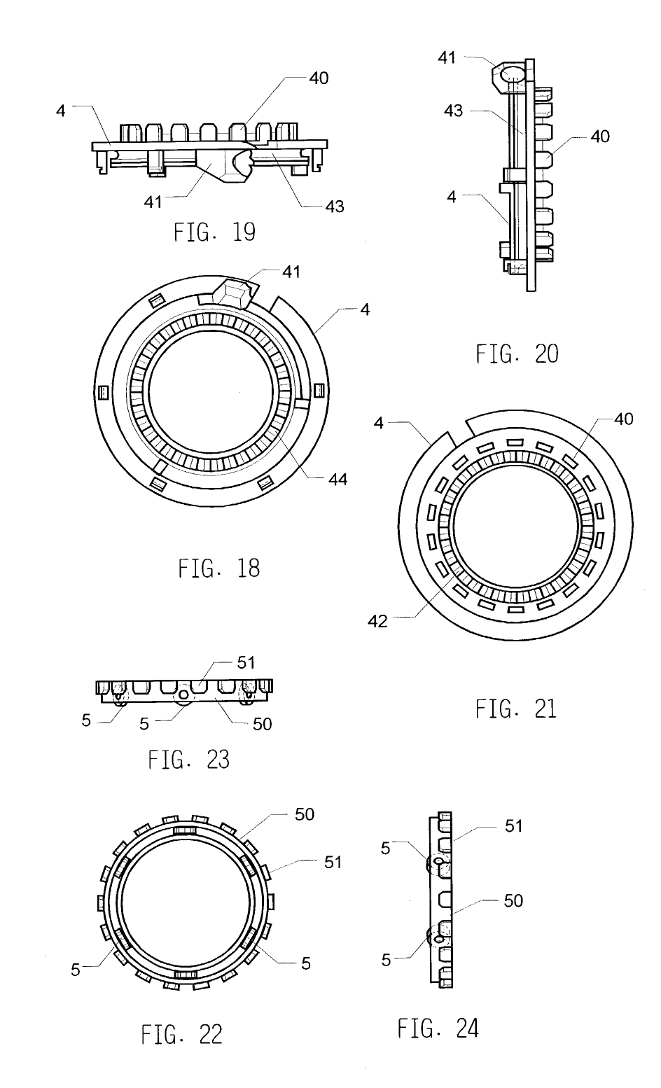

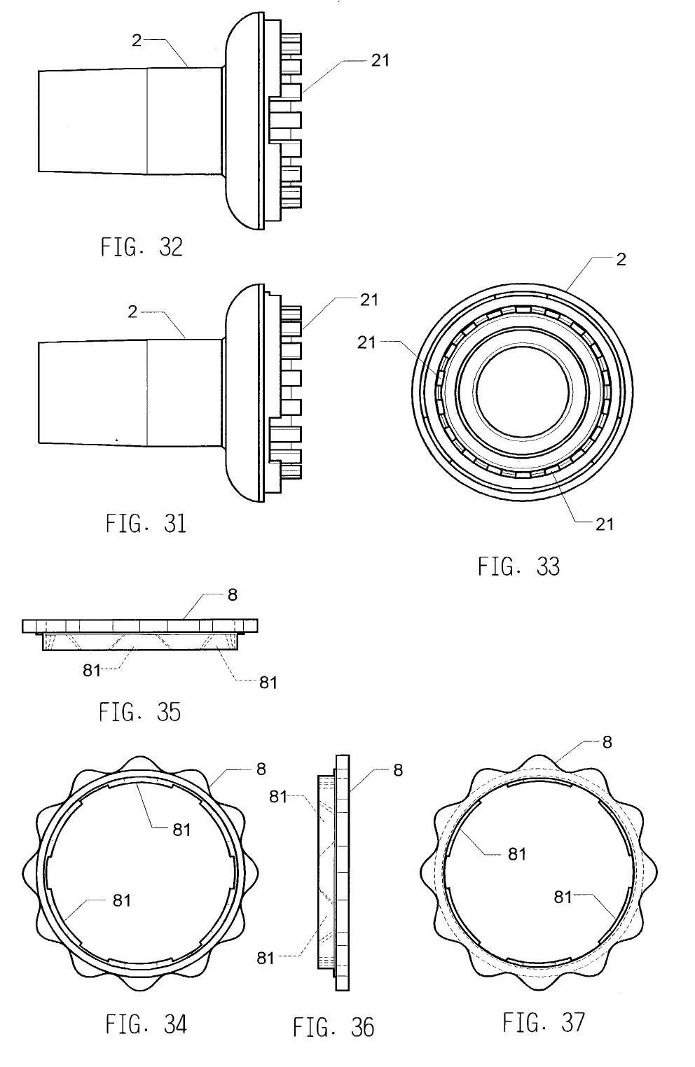

Referring to FIG. 1, the rear rotary sleeve 2 (as shown in FIGS. 31 to 33) is mated with the front casing 1. The front end of the rotary sleeve 2 is provided with driving plates 21 for driving the shift member 3 to synchronously rotate. As shown in FIGS. 28 to 30, the inner circumference of the shift member 3 is provided with inward projecting teeth 31. The driving plates 21 of the rotary sleeve 2 extend into the spaces between the teeth. The horizontal extending length of the driving plates 21 is larger than the thickness of the teeth 31, so that the shift member 3 can be stably driven by the rotary sleeve 2. Springs 22 are positioned between the shift member 3 and the rotary sleeve 2 for constantly biasing and locating the shift member 3. The teeth 31 of the shift member 3 are engaged with the engaging sections 40 of the ring gear 4 (as shown in FIGS. 18 to 21) to drive the ring gear 4 for pulling and releasing the transmission pull cord 17 and shifting the gears one by one. That is, when the rotary sleeve 2 is turned by a set unit angle (between adjacent gears), the ring gear 4 is synchronously rotated by one unit angle to shifting one gear.

In addition, the outer circumference of the shift member 3 is provided with guiding blocks 32 that meshes with guiding blocks 81 formed on inner circumference of the fast ring 8. When the fast ring 8 is rotated, the shift member 3 is driven to horizontally displace by a set distance, so that the teeth 31 of the shift member 3 disengaged from the engaging sections 40 of the ring gear 4 and engaged with the engaging teeth 51 of the gear frame 50 of the planet gear 5. Accordingly, when the rotary sleeve 2 is rotated by a set unit angle, the teeth 31 of the shift member 3 drive the engaging teeth 51 of the gear frame 50 and then the planet gear 5 drives the annular tooth face 42 of the ring gear 4. Accordingly, the ring gear 4 is rotated by a set angle which is several times the rotating angle of the rotary sleeve 2. Therefore, the pull cord 17 is pulled and released for shifting across gears at one time.

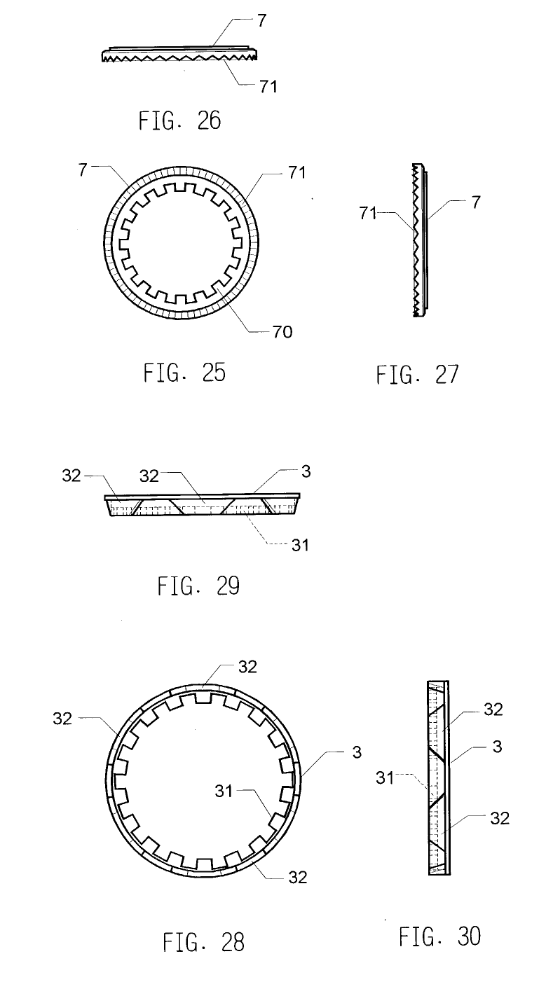

Referring to FIGS. 1 and 22 to 24, the gear frame 50 is provided with the planet gear 5 to engaging the ring gear 4. The outer circumference of the gear frame 50 is provided with engaging teeth 51 with which the shift member 3 is selectively engaged. As shown in FIGS. 25 to 27, the inner circumference of the sun gear 7 is provided with locating teeth 70. One face of the sun gear 7 is formed with an annular tooth face 71 that meshes with the planet gear 5 of the gear frame 50.

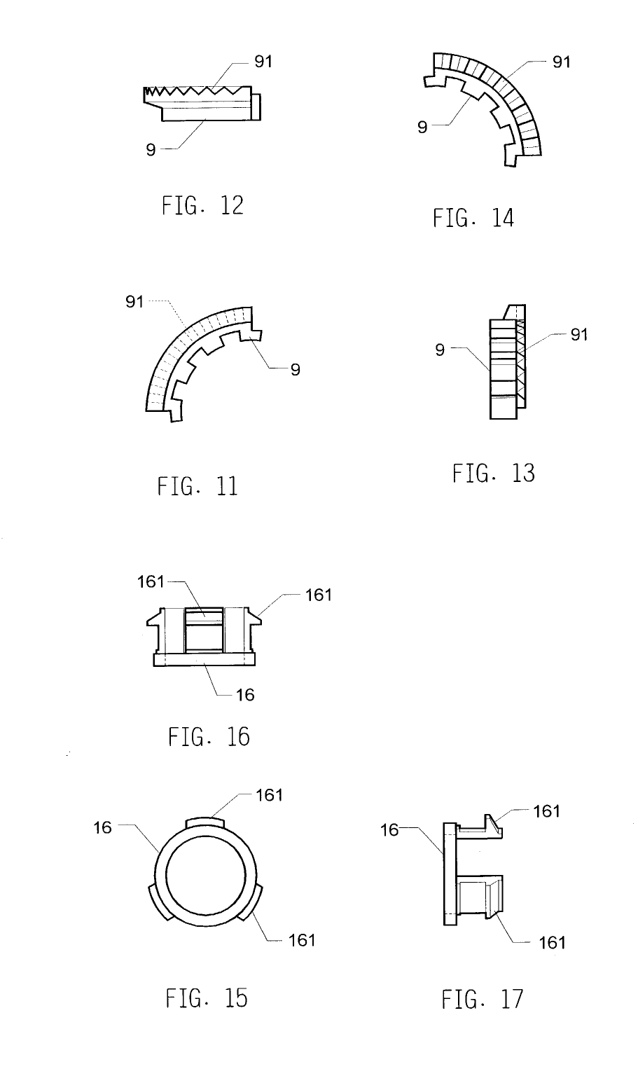

As shown in FIGS. 18 to 21, one face of the ring gear 4 is formed with engaging sections 40 for engaging the engaging teeth 31 of the shift member 3. The same face is provided with an annular tooth face 42 for engaging the planet gear 5. The other face is provided with the pull cord locating seat 41 to connect with an end of the pull cord 17, and is provided with a winding groove 43 in which the pull cord 17 is wound. In addition, the same face is provided with transmission locating tooth face 44 for meshing with a tooth face 91 of the locating member 9 (as shown in FIGS. 11 to 14). Springs 90 are positioned between the locating member 9 and the inner wall of the front casing 1. The locating member 9 provides an adjustable shift locating effect for the ring gear 4.

Please refer to FIG. 1. In normal shifting, the rotary sleeve 2 is engaged with the shift member 3 which is engaged with the ring gear 4. When the rotary sleeve 2 is turned by a set unit angle (between gears), the ring gear 4 is rotated by the set angle to shift to the next gear. Accordingly, the gears are shifted one by one, that is, each time the ring gear 4 is rotated by one unit angle, one gear is shifted.

When it is desired to shift the gears more rapidly (for example, the ratio of the rotational speed of the planet gear is set 1:2), via the fast ring 8, the shift member 3 is displaced and disengaged from the ring gear 4. Instead, the shift member 3 is engaged with the planet gear frame 50 and the planet gear 5 is engaged with the ring gear 4. When the rotary sleeve 2 is rotated by a set unit angle, the ring gear 4 is rotated by a set angle which is several times the unit angle of the rotary sleeve 2. Therefore, each time the rotary sleeve 2 is rotated by one unit angle, the transmission is shifted through several gears.

Accordingly, in a multiple gear transmission, the gears can be sequentially shifted or jump shifted. Therefore, the operation of the shift is more convenient and more quickly performed.

The above embodiment is only used to illustrate the present invention, and is not intended to limit the scope thereof. Many modifications of the above embodiment can be made without departing from the spirit of the present invention.

What is claimed is:

1. A manual shift mechanism of a bicycle, comprising:
a front cord-guiding casing;
a rear rotary sleeve mated with said front cord-guiding casing; and
a shift member disposed between said front cord-guiding casing and said rear rotary sleeve and driven by said rear rotary sleeve, said shift member being displaceable so as to selectively engage a ring gear or a planet gear of a planet gear frame, said planet gear being engaged with said ring gear; wherein
said ring gear is connected with a transmission pull cord, such that shift member engages said ring gear in a first shifting operation in which gears are shifted sequentially, and said shift member is disengaged from said ring gear and engages said planet gear of said planet gear frame in a second shifting operation in which said shift mechanism shift across several gears.

2. The manual shift mechanism of a bicycle as claimed in claim 1, wherein:
said front cord-guiding casing is formed with a cord-guiding arm through which said transmission pull cord is passed to connect with a pull cord locating seat of said ring gear, said front casing being formed with a central passage through which a handle is passed, an entrance of said passage being provided with a locating recess to receive a fixing hoop, the front cord-guiding casing being further formed with a window, an in-built gear number indicator being drivingly connected with said ring gear, and said gear number indicator being visible through said window so as to indicate a shift position of said ring gear.

3. The manual shift mechanism of a bicycle as claimed in claim 1, wherein:
an outer circumference of said fixing hoop is provided with an outward projecting locating block and a projecting block, the locating block being formed with a split therein.

4. The manual shift mechanism of a bicycle as claimed in claim 1, wherein:
a front end of said rotary sleeve is provided with driving plates for driving said shift member, an inner circumference of said shift member being provided with inward projecting engaging teeth, a horizontal length of said driving plates being larger than a horizontal thickness of said engaging teeth.

5. The manual shift mechanism of a bicycle as claimed in claim 1, wherein:
springs are positioned between the shift member and said rotary sleeve to bias said shift member.

6. The manual shift mechanism of a bicycle as claimed in claim 1 wherein:
an outer circumference of said shift member is provided with guiding blocks that mesh with guiding blocks formed on an inner circumference of a fast ring, whereby when said fast ring is rotated, said shift member is horizontally displace by a set distance to cause said engaging teeth of said shift member to disengaged from said engaging sections of said ring gear and to engaged said engaging teeth of said gear frame of said planet gear.

7. The manual shift mechanism of a bicycle as claimed in claim 1, wherein:
planet gears are arranged on said planet gear frame to engage said ring gear, an outer circumference of said gear frame being provided with engaging teeth to selectively engage said shift member.

8. The manual shift mechanism of a bicycle as claimed in claim 1, wherein:
an inner circumference of a sun gear engaged with said gear frame is provided with locating teeth, one face of said sun gear being formed with an annular tooth face that meshes with said planet gear of said gear frame.

9. The manual shift mechanism of a bicycle as claimed in claim 1, wherein:
one face of said ring gear is formed with engaging sections to engage said engaging teeth of said shift member, said one face being provided with an annular tooth face for engaging said planet gear, a second face of said gear being provided with said pull cord locating seat to receive an end of said transmission pull cord, said second face of said ring gear being further provided with a winding groove in which said transmission pull cord is wound, said second face of said ring gear being further provided with a transmission locating tooth face that meshes with a tooth face of a resilient locating member which provides a shift locating effect for said ring gear.
